(19) United States
(12) Patent Application Publication
(10) Pub. No.: US 2024/0168158 A1
(43) Pub. Date: May 23, 2024

(54) Time Difference of Arrival Ranging

(71) Applicant: ZEBRA TECHNOLOGIES CORPORATION, Lincolnshire, IL (US)

(72) Inventors: James J. O'Hagan, McHenry, IL (US); Charles Burton Swope, Coral Springs, FL (US)

(21) Appl. No.: 17/992,914

(22) Filed: Nov. 22, 2022

(51) Int. Cl. G01S 17/08; G01B 11/24

(52) U.S. Cl. CPC G01S 17/08; G01B 11/24; G02B 5/04

(57) ABSTRACT

Imaging devices, systems, and methods for determining a distance to an object using light projected from an illumination device are provided. An example method includes: projecting, from an illumination source of the illumination device, projected light having a first wavelength; receiving, at one or more sensors of the illumination device, reflected light having the first wavelength; receiving, at the one or more sensors of the illumination device, emitted light having a second wavelength; determining, by one or more processors, a phase difference between the reflected light and the emitted light; and determining, by the one or more processors, the distance to the object based at least on the phase difference between the reflected light and the emitted light.

### BACKGROUND

Imaging systems may be used for ranging, dimensioning, locating, and other such measurements. Conventional techniques for such applications may use a time of flight (TOF) sensor to project modulated light onto an object and observe the reflected light to measure the time it takes the light to fly to the object and return to the sensor. By carefully timing the phase shift of the arriving reflected light waves, an algorithm is applied to estimate a distance between the sensor and the reflecting surface. TOF sensors may use a pulsed method or a continuous wave method to estimate distance. Each uses timing windows to measure returned light. The pulsed method uses two time periods in phase with the illumination source and determines a percentage of the reflected light that falls in each time period. Assuming constant reflected intensity and 0 reflection time, multiplying that percentage by the period and the speed of light yields the round-trip distance to the reflective surface. The continuous wave method adds two orthogonal phase measurements to provide four samples, producing a more accurate distance estimate.

However, such conventional techniques have problems with accuracy due to interference (e.g., of ambient or other light striking a sensor) and the inability of the system to quickly factor out noise in the measured data. Similarly, particular types and/or colors of objects cause increased difficulty for TOF dimensioning techniques. For example, objects wrapped in or made of black plastic may cause problems for conventional dimensioning techniques due to the difficulty inherent in reliably detecting and/or differentiating light reflected from such surfaces.

As such, there is a need for improved systems, methods, and devices directed towards ranging, dimensioning, locating, and otherwise determining parameters of an object using optical means.

### SUMMARY

In an embodiment, a method for determining a distance to an object using light projected from an illumination device is provided. The method includes: (A) projecting, from an illumination source of the illumination device, projected light having a first wavelength; (B) receiving, at one or more sensors of the illumination device, reflected light having the first wavelength; (C) receiving, at the one or more sensors of the illumination device, emitted light having a second wavelength; (D) determining, by one or more processors, a phase difference between the reflected light and the emitted light; and (E) determining, by the one or more processors, the distance to the object based at least on the phase difference between the reflected light and the emitted light.

In a variation of the embodiment, the first wavelength is an excitation wavelength of a fluorophore and the second wavelength is an emission wavelength of the fluorophore.

In a variation of the embodiment, the first wavelength is an excitation wavelength of a phosphorescent material and the second wavelength is an emission wavelength of the phosphorescent material.

In an embodiment, receiving the reflected light includes: receiving, at a prism of the illumination device, the reflected light, wherein the prism deviates the reflected light at a first angle based on the first wavelength, and receiving, at a first sensor position of the one or more sensors after the prism deviates the reflected light at the first angle, the reflected light; and receiving the emitted light includes: receiving, at the prism of the illumination device, the emitted light, wherein the prism deviates the emitted light at a second angle based on the second wavelength, and receiving, at a second sensor position of the one or more sensors after the prism deviates the emitted light at the second angle, the emitted light.

In an embodiment, determining the phase difference includes: determining, by the one or more processors, a first phase associated with the reflected light based on at least a first sensor position of the one or more sensors; determining, by the one or more processors, a second phase associated with the emitted light based on at least a second sensor position of the one or more sensors; and determining, by the one or more processors, the phase difference based on at least the first phase and the second phase.

In an embodiment, the first sensor position of the one or more sensors is a first sensor position of a particular sensor of the one or more sensors and the second sensor position of the one or more sensors is a second sensor position of the particular sensor of the one or more sensors.

In an embodiment, receiving the reflected light includes: receiving, at a diffraction grating of the illumination device, the reflected light, wherein the diffraction grating diffracts the reflected light at a first angle based on the first wavelength, and receiving, at a first sensor position of the one or more sensors after the diffraction grating diffracts the reflected light at the first angle, the reflected light; and receiving the emitted light includes: receiving, at the diffraction grating of the illumination device, the emitted light, wherein the diffraction grating diffracts the emitted light at a second angle based on the second wavelength, and receiving, at a second sensor position of the one or more sensors after the diffraction grating diffracts the emitted light at the second angle, the emitted light.

In an embodiment, determining the phase difference includes: determining, by the one or more processors, a first phase associated with the reflected light based on at least the first sensor position; determining, by the one or more processors, a second phase associated with the emitted light based on at least the second sensor position; and determining, by the one or more processors, the phase difference based on at least the first phase and the second phase.

In an embodiment, receiving the reflected light includes: receiving, at a prism of the illumination device, the reflected light, wherein the prism deviates the reflected light at a first angle based on the first wavelength, and receiving, at the one or more sensors after the prism deviates the reflected light at the first angle, the reflected light at a first moment in time; and receiving the emitted light includes: receiving, at the prism of the illumination device, the emitted light, wherein the prism deviates the emitted light at a second angle based on the second wavelength, and receiving, at the one or more sensors after the prism deviates the emitted light at the second angle, the emitted light at a second moment in time.

In an embodiment, determining the distance to the object includes: determining, by the one or more processors, a first time of flight of the reflected light and a second time of flight associated with the emitted light; and calculating, by the one or more processors, the distance to the object based at least on the first time of flight of the reflected light, and the second time of flight associated with the emitted light.

In an embodiment, determining the distance to the object includes: calculating, by the one or more processors, a plurality of estimated distances between the illumination device and a plurality of points on the object; the method further comprising: identifying, by the one or more processors, a shape of the object based on the plurality of estimated distances.

In an embodiment, determining the distance to the object includes: calculating, by the one or more processors, a plurality of estimated distances between the illumination device and a plurality of points on a fluorescent coating; the method further comprising: identifying, by the one or more processors, a pattern of the coating based on the plurality of estimated distances.

In an embodiment, the phase difference is a first phase difference, the emitted light is a first emitted light, and the method further comprising: receiving, at the one or more sensors of the illumination device, second emitted light having a third wavelength; determining, by one or more processors, a second phase difference between the reflected light and the second emitted light; and wherein determining the distance to the object is further based at least on the second phase difference between the reflected light and the second emitted light.

In an embodiment, the method further comprises: calculating, by the one or more processors, dimensions of a label based at least on the first phase difference and the second phase difference.

In an embodiment, the method further comprises: detecting, by the one or more processors, at least one of (i) a plane of the object or (ii) an edge of the object based at least on the phase difference.

In an embodiment, an illumination device capable of determining properties of an object using light projected from the illumination device is provided. The illumination device includes: an illumination source configured to project light towards the object; one or more sensors configured to receive light reflected or emitted from an object; one or more processors and computer-readable media storing machine readable instructions that, when executed, cause the imaging device to: (A) project, from the illumination source, projected light having a first wavelength; (B) receive, at the one or more sensors, reflected light having the first wavelength; (C) receive, at the one or more sensors, emitted light having a second wavelength; (D) determine a phase difference between the reflected light and the emitted light; and (E) determine the distance to the object based at least on the phase difference between the reflected light and the emitted light.

In an embodiment, an object label to be applied to an object is provided. The object label includes: a fluorescent coating that: (A) receives light having a first wavelength; and (B) emits emitted light having a second wavelength; the object label to be applied to an object such that an illumination device: (i) receives the emitted light, (ii) captures an image of the received emitted light, (iii) calculates a distance from the label to the receiving device based at least on a phase difference between the emitted light and reflected light received from the label or the object, and (iv) detects a parameter of the object based on the captured image and the calculated distance.

In an embodiment, an object label to be applied to an object is provided. The object label comprises: a flexible substrate; a luminescent material arranged as a pattern comprising a first portion and a second portion; and an adhesive configured to adhere the object label to the object such that the first portion is positioned in a first position having a first orthogonal direction, and the second portion is positioned in a second position having a second orthogonal direction different than the first orthogonal direction.

In an embodiment, an object label to be applied to an object is provided. The object label comprises: a substrate; a first pattern portion comprising a first luminescent material, the first pattern portion configured to emit first emitted light having a first emitted wavelength in response to receiving first activation light of a first activation wavelength; a second pattern portion comprising a second luminescent material, the second pattern portion configured to emit second emitted light having a second emitted wavelength in response to receiving second activation light of a second activation wavelength; a third pattern zone without either of the first luminescent material or the second luminescent material, the third pattern zone configured to reflect the first activation light and the second activation light; and an adhesive configured to adhere the object label to the object.

In an embodiment, the first luminescent material is different than the second luminescent material, and the first activation wavelength is the second activation wavelength.

In an embodiment, the first activation wavelength is longer than the second activation wavelength.

In an embodiment, an object label to be applied to an object is provided. The object label comprises: a substrate; a first plurality of pattern zones comprising a first luminescent material and configured to emit first emitted light having a first emitted wavelength in response to receiving first activation light of a first activation wavelength; a second pattern zone without the first luminescent material configured to reflect the first activation light; and an adhesive configured to adhere the object label to the object.

In an embodiment, an object label to be applied to an object is provided. The object label comprises: a storage medium storing luminescent material data; and a luminescent material, wherein the luminescent material emits emitted light such that an illumination device: receives the emitted light; captures an image based on the received emitted light; calculates a distance from the label to the receiving device based at least on a phase difference between the emitted light and reflected light received from at least one of the label or the object; and detects a parameter of the object based at least on the captured image and the calculated distance.

In an embodiment, the parameter includes a presence of a first plane of the object and a presence of a second plane of the object.

In an embodiment, the object is a cylinder and the parameter comprises a diameter of the cylinder.

In an embodiment, the storage medium storing the luminescent material data includes a barcode encoding the luminescent material data.

In an embodiment, the barcode comprises the luminescent material and the luminescent material data comprises a wavelength identifier for the luminescent material.

In an embodiment, the storage medium storing the luminescent material data includes an RFID memory storing the luminescent material data.

In an embodiment, the luminescent material data comprises an index of refraction adjustment for the luminescent material.

In an embodiment, the luminescent material data comprises a luminescence lag for the luminescent material.

In an embodiment, the object label further comprises: a pattern portion comprising the luminescent material, wherein the luminescent material data comprises an identifier for the pattern portion.

In an embodiment, the luminescent material data comprises an activation wavelength for the luminescent material.

In an embodiment, the luminescent material data comprises an emission wavelength of the luminescent material.

In an embodiment, the object label further comprises: a temperature sensor. In an embodiment, the object label further comprises: a pressure sensor.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is an example system for illuminating an object, sensing reflected and/or emitted light, and analyzing the resulting data, in accordance with embodiments described herein;

FIG. 2A is a simplified block diagram depicting an illumination device, such as the illumination device of the system in FIG. 1, projecting light and subsequently receiving reflected and emitted light, in accordance with embodiments described herein;

FIG. 2B illustrates example graphs depicting the intensity of light projected and received through a pulsed and continuous wave method, in accordance with embodiments described herein;

FIG. 3 illustrates example object labels depicting different patterns that facilitate detecting various parameters of the object, in accordance with embodiments described herein; and

FIG. 4 illustrates a flow diagram of an example method for determining a distance to an object using light projected from an illumination device, such as the illumination device of FIG. 1, in accordance with embodiments described herein.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Various dimensioning, ranging, locationing, and other distance measuring systems may detect the time of arrival (TOA) of a wireless signal to estimate a distance traveled by the wireless signal. Certain systems may determine a time difference of arrival (TDOA) between two arriving signals to estimate the distance. While a system may be able to determine the time a second signal arrived, determine a time a first signal arrived, and subtract one from the other to determine the TDOA, it may be simpler, faster, or more accurate to directly measure the TDOA between the two arriving signals. Distance measuring systems based on receiving optical signals may have additional limitations because the received light includes both the wireless signal for which timing data must be carefully measured and also ambient light that may act as noise to the signal measurement. As such, an optical distance measurement system relying on a single received signal may perform sub-optimally if the wireless signal to be timed is weak (e.g., was weakly reflected from a dark surface) or if the ambient light is strong (e.g. direct sunlight or high intensity fluorescent lights). A system that receives two signals (such as two beams of light) may more accurately determine the distance to an object, as well as various parameters (e.g., characteristics) of the object. To receive such signals, a system implementing techniques as discussed herein may use a reflective surface (e.g., made of, including, or coated in a luminescent material such as a fluorophore) that receives a projected light at a first wavelength and emits two or more signals: a reflected wave at the first wavelength and an emitted luminescent (e.g., fluorescent, phosphorescent, etc.) wave at a different wavelength. Similarly, a single illumination burst may produce two emitted signals by using multiple materials and/or coatings for the reflective surface. When such signals are received by the illumination device the illumination device determines the phase shift between the signals and uses the phase shift to estimate the distance to the reflective/emitting surface.

To utilize an object made of a reflective material that reflects and emits light as described above, a system may use an object that is stained with fluorochrome stains that absorb illumination light of a first wavelength and emit fluorescent light at a second wavelength. By filtering the emitted light from reflected illumination light, a high contrast image of the stained components may be created. Items such as tags, labels, wristbands, etc. have been printed or coated with fluorochrome stains for improving readability and/or confirming authenticity. Similar techniques may be used to create an object made of material as described above. Further, it will be understood that, although the disclosures herein refer largely to fluorescent materials, phosphorescent or other luminescent materials may similarly be used, so long as, for example, the decay time of the phosphorescent light is known.

By performing a TDOA analysis on light received from an object including a luminescent material or label, an illumination device as described herein may more quickly and accurately determine a distance to the object as well as determine various characteristics of the object, such as range to the object, dimensions of the object, or location of the object in a defined geographic information system. Similarly, a system using such techniques can determine such characteristics for a wider array of objects, including those that may be difficult to dimension according to conventional techniques, and may similarly eliminate noise that would be prevalent in a system performing said conventional techniques.

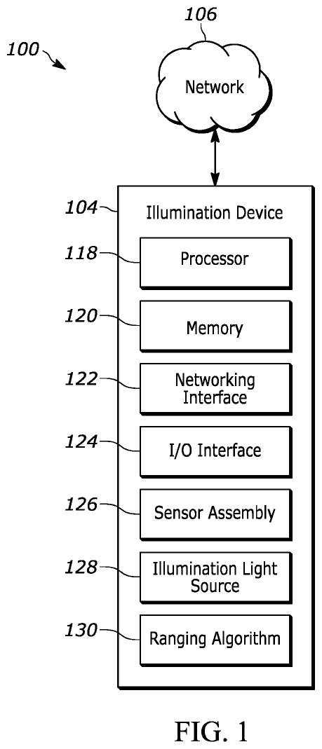

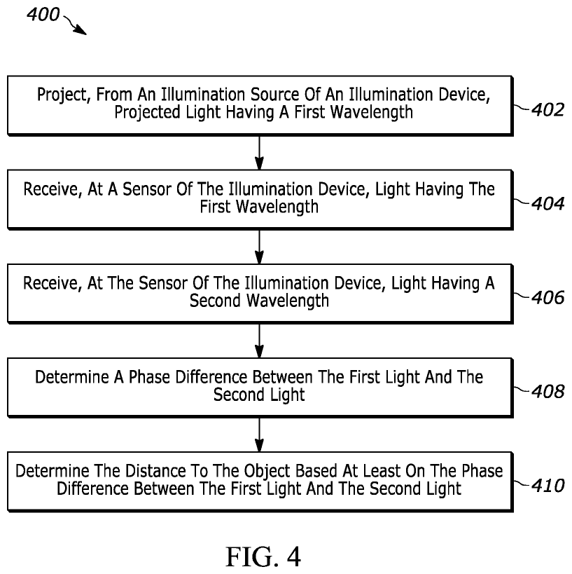

Referring now to FIG. 1, an example system 100 configured to transmit and receive light to determine a distance to an object is illustrated, in accordance with various implementations disclosed herein. In the example implementation of FIG. 1, the imaging system 100 includes an illumination device 104 that may be communicatively coupled to one or more other devices (e.g., an external computing device, an external light source, an external server, an external display, etc.) via a network 106. Generally speaking, the illumination device 104 may be capable of executing instructions to, for example, implement operations of the example methods described herein, as may be represented by the flowcharts of the drawings that accompany this description, such as the method 400 as shown at FIG. 4. It will be understood that, although FIG. 1 depicts a single illumination device 104, the illumination device 104 may share functionality with one or more separate devices coupled via the network 106. Similarly, although components of the illumination device 104 are depicted as separate components of a single system device, it will be understood that one or more components may be external to the illumination device 104.

The illumination device 104 is generally configured to receive light from an object, generate data regarding the light, and use the generated data to calculate a distance to the object and/or various properties of the object as described herein. The illumination device 104 may include one or more processors 118, one or more memories 120, a networking interface 122, an input/output (I/O) interface 124, a sensor assembly 126, an illumination light source 128, and/or a ranging algorithm 130.

The illumination device 104 may be configured to project light towards an object, receive light reflected and/or emitted by the object, and/or transmit data regarding the received light or the object to one or more external computing devices (not shown). Depending on the implementation, the illumination device 104 may be communicatively coupled to other devices (e.g., external computing devices, an external monitor, a mobile computing device, etc.) via a wired or wireless connection and/or via the network 106. Generally, the illumination device 104 may receive instructions as an indication directly from the user that may cause the illumination device 104 to project light from an illumination light source 128.

Depending on the implementation, the illumination light source 128 may be a laser or other such coherent light source, an LED, a black light, and/or any other such light source capable of projecting light from the illumination device 104 towards the object 208. In some implementations, the illumination device 104 includes a single illumination light source 128, and the indication is an instruction to turn the single illumination light source 128 on or off. In further implementations, the illumination device 104 includes multiple illumination light sources 128, and the indication is an instruction of which light source of the illumination light sources 128 to turn on or off. In still further implementations, the indication includes instructions regarding a wavelength of light to project, expected wavelength(s) of light to receive, a time period during which to project light, an intensity at which to project light, a frequency in which to project light, and/or other similar parameters as described herein.

After projecting light from the illumination light source(s) 128, the illumination device 104 receives light at the sensor assembly 126. In some implementations, the illumination device 104 may control the sensor assembly 126 or a shutter for the sensor assembly 126 such that the illumination device 104 only receives light after projecting light from the illumination light source(s) 128.

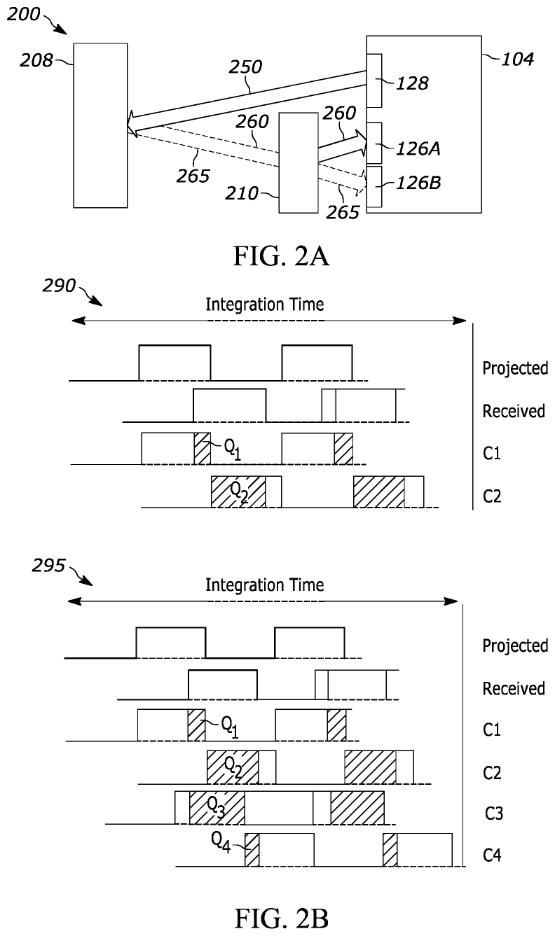

Depending on the implementation, the sensor assembly 126 may include one or more sensors that detect when light impinges on the light sensor(s) (also referred to as “imaging sensors,” “light sensors,” and/or “imagers”). In some implementations, the sensor assembly 126 additionally includes one or more optical elements such as prisms, lenses, mirrors, diffraction gratings, transmission gratings, and/or other similar optical elements to redirect received light to particular sensors and/or positions on sensors, as described in more detail below with regard to FIG. 2A.

The light sensors of, e.g., the sensor assembly 126 may be configured, as disclosed herein, to measure reception time, time of flight, wavelength, etc. of received light and, at least in some implementations, may store such data in a memory (e.g., one or more memories 120) of a respective device (e.g., illumination device 104).

For example, the sensor assembly 126 may include one or more sensors positioned to receive light reflected from the object 208 (as described in more detail below with regard to FIG. 2A). Depending on the implementation, the sensor assembly 126 may be or include a single sensor or multiple sensors, each positioned to receive a different wavelength of light. In some implementations, the sensor assembly 126 includes or is positioned behind an optical element that causes light to deviate based on wavelength, such as a prism, diffraction grating, etc. Depending on the implementation, the positions to which the different wavelengths of light are deviated corresponds to the placement of the sensor(s) such that the sensor(s) may receive the deviated light.

In some implementations, the illumination device 104 stores operation data and/or data regarding the received light at a memory 120. As an example, the illumination device 104 may include flash memory used for determining, storing, or otherwise processing data regarding received light. In further implementations, the illumination device 104 discards, disregards, and/or otherwise determines not to save data in the memory 120 related to light received before projecting light from the illumination light source 128. As such, the illumination device 104 may, depending on the implementation, automatically transmit data related to the received light to an external memory source (e.g., a server, computing device, RFID tag, etc.), and automatically discard data unrelated to the received light. In further implementations, the illumination device 104 may temporarily store the data related to the received light and may transmit the results to the external memory source (not shown) in response to determining that the data is related to the received light. In some implementations, the illumination device 104 determines that the data is related to the received light based on characteristics of the light, such as matching an expected wavelength of the received light.

The illumination device 104 may further process the data regarding received light to determine one or more parameters regarding the light and/or the object reflecting/emitting light. For example, the one or more processors 118 may process the data measured, sensed, and/or otherwise determined by the sensor assembly 126. The illumination device 104 may calculate, measure, and/or otherwise determine parameters such as a range or distance between the illumination device 104 and the object, various characteristics of the object (a shape, size, edge, etc.), various characteristics of labels or coatings on the object (e.g., a pattern, a size, a type, etc.), and/or other similar features as described herein. In particular, the illumination device may execute a ranging algorithm 130 for viewing, manipulation, and/or data generation. In other implementations, the image data and/or the post-imaging data may be sent to a server or external computing device for storage or for further manipulation. As described herein, the illumination device 104, external computing device, and/or external server or other centralized processing unit and/or storage may store such data, and may also send the data and/or the processed data to another application implemented on a user device, such as a mobile device, a tablet, a handheld device, or a desktop device.

Each of the one or more memories 120 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. In general, a computer program or computer based product, application, or code (e.g., ranging algorithm 130, or other computing instructions described herein) may be stored on a computer usable storage medium, or tangible, non-transitory computer-readable medium (e.g., standard random access memory (RAM), an optical disc, a universal serial bus (USB) drive, or the like) having such computer-readable program code or computer instructions embodied therein, wherein the computer-readable program code or computer instructions may be installed on or otherwise adapted to be executed by the one or more processors 118 (e.g., working in connection with the respective operating system in the one or more memories 120) to facilitate, implement, or perform the machine readable instructions, methods, processes, elements or limitations, as illustrated, depicted, or described for the various flowcharts, illustrations, diagrams, figures, and/or other disclosure herein. In this regard, the program code may be implemented in any desired program language, and may be implemented as machine code, assembly code, byte code, interpretable source code or the like (e.g., via Golang, Python, C, C++, C#, Objective-C, Java, Scala, ActionScript, JavaScript, HTML, CSS, XML, etc.).

The one or more memories 120 may store machine readable instructions, including any of one or more application(s), one or more software component(s), and/or one or more application programming interfaces (APIs), which may be implemented to facilitate or perform the features, functions, or other disclosure described herein, such as any methods, processes, elements or limitations, as illustrated, depicted, or described for the various flowcharts, illustrations, diagrams, figures, and/or other disclosure herein. The one or more memories 120 may, for example, store the ranging algorithm 130, which may be used to facilitate ranging, dimensioning, scanning, etc., as described further herein. Additionally, or alternatively, the ranging algorithm 130 may also be stored in an external database (not shown), which is accessible or otherwise communicatively coupled to the illumination device 104 via the network 106.

The one or more processors 118 may be connected to the one or more memories 120 via a computer bus responsible for transmitting electronic data, data packets, or otherwise electronic signals to and from the one or more processors 118 and one or more memories 120 to implement or perform the machine readable instructions, methods, processes, elements or limitations, as illustrated, depicted, or described for the various flowcharts, illustrations, diagrams, figures, and/or other disclosure herein, e.g., such as the method 400 as shown at FIG. 4.

The one or more processors 118 may interface with the one or more memories 120 via the computer bus to execute the instructions described herein. The one or more processors 118 may also interface with the one or more memories 120 via the computer bus to create, read, update, delete, or otherwise access or interact with the data stored in the one or more memories 120 and/or external databases (e.g., a relational database, such as Oracle, DB2, MySQL, or a NoSQL based database, such as MongoDB).

The networking interface 122 may be configured to communicate (e.g., send and receive) data via one or more external/network port(s) to one or more networks or local terminals, such as network 106, described herein. In some implementations, networking interface 122 may include a client-server platform technology such as ASP.NET, Java J2EE, Ruby on Rails, Node.js, a web service or online API, responsive for receiving and responding to electronic requests.

According to some implementations, the networking interface 122 may include, or interact with, one or more transceivers (e.g., WWAN, WLAN, and/or WPAN transceivers) functioning in accordance with IEEE standards, 3GPP standards, or other standards, and that may be used in receipt and transmission of data via external/network ports connected to network 106. In some implementations, network 106 may comprise a private network or local area network (LAN). In some implementations, the network 106 may comprise routers, wireless switches, or other such wireless connection points communicating to the illumination device 104 (via networking interface 122) via wireless communications based on any one or more of various wireless standards, including by non-limiting example, IEEE 802.11a/b/c/g (WIFI), the Bluetooth standard, or the like.

The I/O interface 124 may include or implement operator interfaces configured to present information to an administrator or operator and/or receive inputs from the administrator or operator. The I/O interface 124 may also include I/O components (e.g., ports, capacitive or resistive touch sensitive input panels, keys, buttons, triggers, lights, LEDs, any number of keyboards, mice, USB drives, optical drives, screens, touchscreens, etc.), which may be directly/indirectly accessible via or attached to the illumination device 104.

As described above, in some implementations, the illumination device 104 may perform the functionalities as discussed herein as part of a “cloud” network or may otherwise communicate with other hardware or software components within the cloud to send, retrieve, or otherwise analyze data or information described herein.

FIG. 2A is a simplified block diagram of a system 200 using the illumination device 104 of FIG. 1 to project light toward an object 208, in accordance with implementations described herein. Further, the illumination device 104 receives reflected light at a first sensor 126A and emitted light at a second sensor 126B. Similarly, FIG. 2B depicts graphs 290 and 295 of the illumination of an illumination light source and reflected light in a pulsed and continuous wave time of flight detection. The illumination device 104 may include an illumination light source 128 and one or more sensors 126A and/or 126B as described with regard to FIG. 1 above.

The illumination device 104 projects light 250 from the illumination light source 128 towards an object 208. Depending on the implementation, the object 208 may be a package including a label with a luminescent (e.g., fluorescent, phosphorescent, etc.) ink; a package wrapped, painted, or otherwise coated in a luminescent material; a package including a luminescent material; a pallet with a packing slip including luminescent ink; etc. Depending on the implementation, the object 208 may be a 1 inch by 1 inch by 1 inch cube, a 1 foot by 1 foot by 1 foot cube, a 4 foot by 4 foot by 4 foot cube, a 1 foot by 2 foot by 3 foot cuboidal, a 48 inch by 40 inch by 4 foot pallet, etc. Similarly, the object 208 may be any appropriate shape and/or size. Depending on the implementation, the object 208 may be a variable distance away from the illumination device 104. For example, the object may be 1 inch away, 6 inches away, 1 foot away, 2 feet away, 4 feet away, 8 feet away, 30 feet away, etc.

In some implementations, the illumination device 104 projects the light 250 in response to an indication from a user, such as a trigger pull, button push, spoken command, etc. In further implementations, the illumination device 104 projects the light 250 in response to an indication from a user via a computing device. In still further implementations, the illumination device 104 projects the light 250 in response to detecting or receiving an indication of an object 208, a coating applied to an object 208, or a label; decoding data from a bar code or RFID tag associated with the object; etc.

Depending on the implementation, the illumination device 104 may project light of a predetermined wavelength. For example, in implementations in which the object is coated by and/or otherwise includes a fluorophore, phosphorescent material, or other such material, then the illumination device 104 may project light such that the projected light 250 has a wavelength including the excitation wavelength for the material in question. As used herein, the excitation wavelength refers to a wavelength that causes the material to emit light at a second wavelength. For example, the object may be a fluorophore with an excitation wavelength in the ultraviolet (UV) range. As such, the illumination device 104 may emit UV light toward the fluorophore to cause the fluorophore to emit fluorescent light.

In some implementations, the illumination device 104 includes a single illumination source 128, and therefore projects light according to the capabilities of the illumination source 128 (e.g., only UV light). In further implementations, the illumination device 104 includes multiple or variable illumination sources 128. In some such implementations, the illumination device 104 determines the wavelength of light to project based on an indication such as an input from a user to the illumination device 104, an input from a user via a computing device, etc. In further implementations, the illumination device 104 displays a list of materials, label types, objects, etc. for the user to choose, and the illumination device 104 determines the wavelength of light to project in response to the user choice.

The projected light 250 travels at a speed v over a distance d from the device to the surface. In a vacuum, the speed ν is the speed of light,

$$c \approx 299 , 792 , 458 \frac{m}{s} .$$

In air, the speed is slightly lower,

$$v = \frac{c}{n} ,$$

where n is the index of refraction for air, approximately 1.0003. In some implementations, the system 200 assumes that operations occur in air rather than a vacuum or other medium unless the illumination device 104 receives an indication to the contrary (e.g., from the user). In further implementations, the projected light 250 has a duration f (which may vary with certain modulation schemes), and a travel time from the device to the surface of T_{I}.

Upon receiving the projected light 250 from the illumination device 104, the object 208 reflects at least some of the light as reflected light 260. In some implementations, because the time for the light to reflect is very short (e.g., on the order of 10⁻¹⁷ seconds), the illumination device 104 treats the time to reflect as T_{B}≈0 for any calculations. The reflected light 260 returns from the object 208 to the illumination device 104. In particular, the reflected light 260 impacts with a sensor 126A of the illumination device 104. Depending on the implementation, the reflected light 260 may follow the same path or substantially the same path as the projected light 250, and thus the travel time T_{R}≈T_{I}.

In some implementations, the total time of travel (also referred to as time of flight) is given by equation 1 as follows: T_{Tr}=T_{I}+T_{B}+T_{R}. The total time of travel may also be equal to the overall phase shift for the reflection of the light with measured illuminations Q₁, Q₂, Q₃, Q₄ as illustrated in the pulsed wave graph 290 and continuous wave graph 295 of FIG. 2B. As such, the total time of travel is also given by equation 2 as follows:

$${T}_{Tr} = \frac{ϕ}{2 π f} ,$$

where tan

$$( ϕ ) = \frac{{Q}_{3} - {Q}_{4}}{{Q}_{1} - {Q}_{2}}$$

Since T_{I}≈T_{R}and

$${T}_{B} \approx 0 , \frac{arctan ( \frac{{Q}_{3} - {Q}_{4}}{{Q}_{1} - {Q}_{2}} )}{2 π f} \approx {T}_{R} + 0 + {T}_{R} .$$

As such, the time of travel for the reflected light is given by equation 3:

$${T}_{R} \approx \frac{arctan ( \frac{{Q}_{3} - {Q}_{4}}{{Q}_{1} - {Q}_{2}} )}{4 π f} ,$$

and the distance is given by equation 4:

$$d = vt = \frac{c}{n} \frac{arctan ( \frac{{Q}_{3} - {Q}_{4}}{{Q}_{1} - {Q}_{2}} )}{4 π f}$$

for the reflected light 260.

In further implementations, the object 208 emits additional light (e.g., emitted light 265) in addition to reflecting light back at the illumination device 104, such as when the object 208 is, is coated by, or otherwise includes a luminescent material such as a fluorescent material, phosphorescent material, etc. In such implementations, the object 208 absorbs at least part of the projected light 250, which excites electrons within the luminescent material. The object 208 may emit the emitted light 265 from the point of reflection for the reflected light 260, e.g., the point of incidence for the received projected light. As such, the emitted light 265 may travel the same path as the reflected light 260 until reaching an optical element 210 as described in more detail below. Although the emitted light 265 and the reflected light 260 may share a starting point, the beams have different wavelengths so they travel through the medium (e.g. air) at different speeds such that each beam of light may arrive at the one or more sensors (e.g., sensors 126A and 126B) at different moments in time, allowing the illumination device 104 to determine a time difference of arrival, as discussed herein.

The reflected light 260 has a wavelength of λ_{R}. In such implementations, the electrons return to an initial state and emit the additional energy as emitted light 265 with another wavelength λ_{F} (e.g., fluorescing light for a fluorescent material, phosphorescent light for a phosphorescent material, etc.).

As described above, the object 208 may emit the emitted light 265 when the projected light 250 has a wavelength matching an excitation wavelength of the fluorescent material. As one example, the object 208 is coated at least partially with a fluorescing dye, such as Fura-2. In such an example, the projected light 250 may cause the object 208 to emit light when the projected light 250 has a wavelength in the UV spectrum (e.g., 340 nm or 380 nm), and the emitted light 265 may have a wavelength in the visible spectrum (e.g., 510 nm). In such implementations, then, the reflected light 260 may have a first wavelength λ_{R} matching the projected light wavelength, and the emitted light 265 may have a second, different wavelength λ_{F}.

In some implementations, the system 200 includes an optical element 210 placed between the object 208 and the sensor(s) 126A and 126B. The optical element 210 may be and/or include a prism, a diffraction grating, optical filters, mirrors, lenses, a transmission grating, and/or any other similar optical element that separates light based on the wavelength. Depending on the implementation, the optical element 210 may be part of the one or more sensors 126A and 126B, part of the illumination device 104, positioned between the one or more sensors 126 and the object 208, positioned externally to the illumination device 104, etc.

In some such implementations, the optical element 210 redirects the reflected light 260 and/or the emitted light 265 to the one or more sensors 126A and 126B, respectively, based on the wavelength of the respective light, as illustrated by FIG. 2A. Depending on the implementations, the one or more sensors may be different sensors (e.g., sensors 126A and 126B), each positioned to receive one of the reflected light 260 or the emitted light 265; the same sensor, positioned to receive the reflected light 260 and the emitted light 265 at different positions; the same sensor positioned to receive the reflected light 260 and the emitted light 265 at different times at the same position; etc.

In some implementations, the time for the excitation and emission of the emitted light 265 to occur T_{F} is longer than the reflection time T_{B}. In further implementations, the emitted light 265 travels at a speed ν_{F} over the distance d from the object 208 to the illumination device 104. In air,

$${v}_{F} = \frac{c}{{n}_{e}}$$

where nₑ is the index of refraction for air. Because the index of refraction depends on the wavelength of the light passing through, the air may have an index of refraction nₑ for the emitted light 265 different than the index of refraction nᵢ for the projected light 250 and/or reflected light 260. The emitted light 265 has a travel time from the object 208 to the illumination device 104 of T_{E}.

In some implementations, the illumination device 104 calculates the total round trip time for the emitted light according to equation 5: T_{Te}=T_{I}+T_{F}+T_{E}. In some implementations, the emitted light 265 and the reflected light 260 travel the same distance, and therefore the distance is determined by equation 6:

$$d = \frac{c}{{n}_{e}} {T}_{E} = \frac{c}{{n}_{i}} {T}_{R} .$$

As such,

$${T}_{R} = \frac{{n}_{i}}{{n}_{e}} {T}_{E} .$$

Because T_{Tr}=T_{I}+T_{B}+T_{R}and T_{Te}=T_{I}+T_{F}+T_{E}, the difference in total trip time is determined according to equation 7:

$${T}_{Te} - {T}_{Tr} = {T}_{F} - {T}_{B} + {T}_{E} - {T}_{R} = ( {T}_{F} - {T}_{B} ) + {T}_{E} - \frac{{n}_{i}}{{n}_{e}} {T}_{e} = ( {T}_{F} - {T}_{B} ) + \frac{{n}_{e} - {n}_{i}}{{n}_{e}} {T}_{E} .$$

As such, according to equation 8:

$${T}_{E} = ( ( {T}_{Te} - {T}_{Tr} ) - ( {T}_{F} - {T}_{B} ) ) \frac{{n}_{e}}{{n}_{e} - {n}_{i}} .$$

Therefore, the system 200 can determine the distance according to equation 9:

$$d = \frac{c}{{n}_{e}} {T}_{E} = ( ( {T}_{Te} - {T}_{Tr} ) - ( {T}_{F} - {T}_{B} ) ) \frac{c}{{n}_{e} - {n}_{i}} .$$

The distance equation may therefore rely on three measurements: the time difference of arrival (TDOA), the index of refraction adjustment, and the luminescence (e.g., fluorescence, phosphorescence, etc.) lag. In further implementations, other factors may further affect the distance equation, such as projection of light through a medium other than air (e.g., water, helium, glass, quartz, ethanol, polycarbonate, Plexiglas, etc.).

The system 200 may determine the TDOA by determining a value for T_{Te}−T_{Tr}. In some implementations, the system 200 may determine T_{Te} and T_{Tr} independently. In some such implementations, the system 200 determines each of T_{Te} and T_{Tr} according to the intensity of the emitted light 265 (F) or reflected light 260 (Q), respectively, as received at sensor(s) 126A and/or 126B, configured to determine intensity of received light (e.g., such as a Texas Instrument (TI) time of flight sensor as described in TI whitepaper SLOA190B). As such, the system 200 may determine the TDOA by determining a phase difference of the light via equation 10:

$${T}_{Te} - {T}_{Tr} = \frac{arctan ( \frac{{F}_{3} - {F}_{4}}{{F}_{1} - {F}_{2}} ) - arctan ( \frac{{Q}_{3} - {Q}_{4}}{{Q}_{1} - {Q}_{2}} )}{2 π f}$$

using values for Q and F according to FIG. 2B.

In an embodiment, the system 200 may determine the TDOA by determining a time of impact for light at a first sensor 126A and determining a time of impact for light at a second sensor 126B. The system 200 may then determine the TDOA between the first time of impact and the second time of impact between the two sensors 126A and 126B. In some implementations, the system 200 may automatically determine that impact has occurred when the sensor 126A and/or 126B receives light of a predetermined wavelength. As such, in some such implementations, the system 200 does not determine the TDOA based on the intensity of the received light. Depending on the implementation, the system 200 may use a common clock between the sensors 126A and 126B to ensure an accurate comparison in time of arrival for each sensor.

In an embodiment, the system may use a filter for λ_{R} and λ_{F} implemented in, on, or with the sensor(s) 126A and/or 126B. Because the intensity ratio is constant over the time of the arriving pulse, the system 200 may compare slopes of light intensity to determine a time at which the second (e.g., emitted light 265) pulse begins. In an embodiment, receiving the reflected light 260 may cause a component of the system (e.g., the illumination device 104, an external computing device, etc.) to start a timer that may end in response to receiving the emitted light 265. Depending on the implementation, the illumination device 104 may buffer the received signal representative of the reflected light 260 and the emitted light 265. The illumination device 104 may then search for a start bit modulation pattern in each light beam, representative of the particular light. Similarly, the illumination device 104 may image the reflected light 260 beam and the emitted light 265 beam to analyze the intensity, polarity, diffraction pattern, Moiré pattern, etc. to determine a phase difference and, subsequently, the TDOA.

The system 200 may determine the index of refraction adjustment by determining a value for nₑ−nᵢ. For a system as described herein that is determining time difference of arrival (TDOA) between emitted light 265 and reflected light 260 of the same wavelength as the projected light 250, the index of refraction adjustment depends on both (i) the medium through which the received light has traveled (e.g., air) and (ii) the wavelengths of the activation light and emitted light resulting from the luminescent material carried by the object 208. In some implementations, the system 200 may determine the index of refraction adjustment experimentally and store the determined value for later use, either prior to performing a ranging operation or during a device calibration period. In an embodiment, the illumination device 104 may adjust the index of refraction associated with a compressible fluid medium (e.g., air) by including a pressure sensor (not shown), such as an ambient pressure sensor, microphone, etc., that measures the pressure of the surrounding area. As n for a gas varies with pressure, the system 200 may then determine the index of refraction adjustment based on the pressure measurement. Similarly, the illumination device 104 may include additional sensors, such as sensors for temperature, humidity, carbon dioxide (CO₂) content, microwave radiation, etc. The illumination device 104 may use the measurements from the sensors to determine the index of refraction adjustment. Depending on the implementation, the sensors may be electronic sensors integrated into the illumination device 104, remote sensors with which the illumination device 104 is communicatively coupled, a visible sensor (e.g., thermometer or TempTime® visual indicator) on the object 208 that the illumination device 104 simultaneously reads, an RFID sensor or datalogger in the object that is communicatively coupled with the illumination device 104, etc. In an embodiment, an index of refraction adjustment for a luminescent material is encoded in a barcode printed on a label affixed to the object, wherein the label comprises the luminescent material. In an embodiment, the index of refraction adjustment for a luminescent material is encoded in a memory of an RFID tag carried by the object, wherein the object includes the luminescent material. In an embodiment, an object label comprising a visual indicator is configured to alter a pattern in response to temperature such that an illumination device receiving light from the pattern may determine a temperature of the object label.

The system 200 may determine the luminescence lag by determining a value for T_{F}−T_{B}. In some implementations, the luminescence lag is consistent for a given dye, coating, material, etc. at a predefined illumination and emission wavelength. In such implementations, the illumination device 104 may be set at manufacture, when a particular component is installed, at calibration, etc. In further implementations, the value is encoded into a label, packaging, coating, etc. on an object 208. Depending on the implementation, a dye, coating, material, etc. may be incorporated into an object 208 by floodcoating an adhesive label or RFID smartlabel, incorporating the dye into cardboard or synthetic boxes, incorporating the dye into visibly transparent or opaque wrap, incorporating the dye into a pallet and/or other such object, incorporating the dye into a packing slip holder, incorporating the dye into a printable ink, etc. In an embodiment, a label comprising the dye, coating, materials, etc. also includes a barcode encoding the luminescence lag. In an embodiment, a label comprising the dye, coating, materials, etc. also comprises an RFID tag including memory indicating the luminescence lag.

Depending on the implementation, timing relationships between certain components of the illumination device 104 (such as the sensor assembly 126, the clock circuit, optics, processor 118, etc.) may vary based on the temperature of the components, or timing aspects of system 100 may vary based on temperature. Such timing variations may cause inaccuracy in determining distances using TDOA calculations. The calculations, therefore, may be adjusted by experimentally determining temperature adjustment factors that vary by temperature, determining an operational temperature for the system, and/or applying the temperature dependent temperature adjustment factors when calculating distance or TDOA by the ranging algorithm 130. The operational temperature may be measured by a temperature circuit of the illumination device 104, measured by a thermistor of an illumination device system, received by the illumination device 104 via the networking interface 122, imaged by the sensor assembly from a visual indicator on an object label or thermometer, or determined via other means.

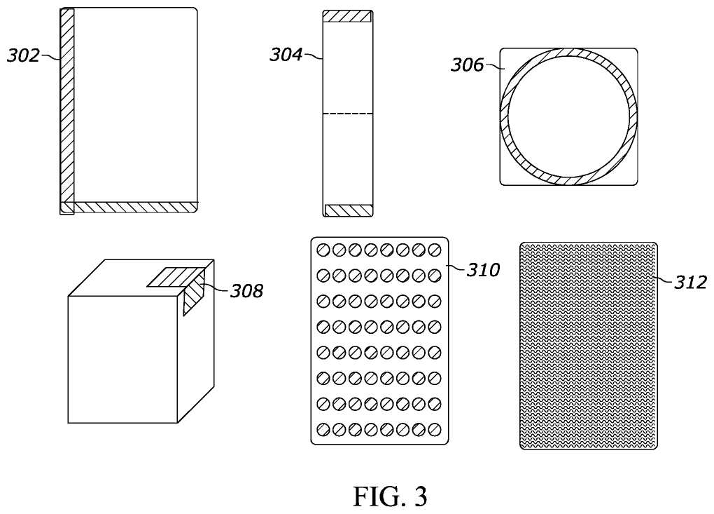

FIG. 3 depicts example labels to be applied to an example object (e.g., object 208), each label incorporating a luminescent dye. Each example label depicts a pattern of a luminescent material (e.g., printed using a fluorescent ink, dyed with a phosphorescent dye, made of a luminescent synthetic material, etc.). In an embodiment, a label comprises a flexible substrate (e.g., paper, polyester, etc.) including a luminescent material and an adhesive configured such that a first portion of the luminescent material may be adhered to a first position of an object in a first orientation and a second portion of the luminescent material may be adhered to the object in a different orientation. Depending on the implementation, an illumination device (e.g., illumination device 104) may determine one or more parameters of the object 208 based on the pattern. In some implementations, the luminescent pattern is invisible to the human eye until the object receives light having an excitation wavelength. A sensor assembly 126 of the illumination device 104 may be configured to receive light from a field of view and capture an image of the light pattern to memory 120. The received light from which the image is captured may comprise light 260 reflected from the projected light 250, light 265 emitted by the luminescent material in response to receiving the activation light of an excitation wavelength, light reflected from other ambient sources (e.g. sunlight, ceiling fixtures, etc.), or any combination thereof. Although the labels of FIG. 3 are described below with regard to illumination device 104, object 208, and/or other components of the system 100 as illustrated in FIG. 1, it will be understood that other similarly suitable devices and components may be used instead.

Each example label of FIG. 3 carries a luminescent material, but each also provides a surface that may define a pattern associated with the light received at an illumination device 128 from an object 208 such as the example label. Various use cases may benefit from various combinations of these patterns when combined with the ability of the illumination device 104 to determine a distance from the label by determining TDOA associated with light emitted from the luminescent material. In a first embodiment, an illumination device projects activation light, receives emitted light and reflected light from an object, determines TDOA data, determines a distance from the object based on the received light, captures a two-dimensional (2D) image of light received from a field of view, decodes object data based on the captured image, and/or determines one or more parameters of the object 208 based on the determined distance and the decoded object data. In a second embodiment, an illumination device projects activation light having a structured pattern, receives emitted light from a plurality of points on a surface of an object, determines three dimensional (3D) data for the plurality of points based on the emitted light, and/or determines one or more parameters of the object 208 based on the determined 3D data. In a third embodiment, an illumination device projects activation light, receives emitted light from a pattern of luminescent materials on a surface of an object, determines three dimensional (3D) data for the plurality of points based on the emitted light, and/or determines one or more parameters of the object 208 based on the determined 3D data. Each embodiment determines distance based on receiving emitted light and determines additional data based on detecting patterns from a plurality of point data: for example, from a captured 2D image of visible features in the first embodiment, from a 3D point cloud resulting from a projected structured light pattern in the second embodiment, from a 3D point cloud resulting from a printed pattern of luminescent material in the third embodiment, etc.

In some implementations, a label, such as exemplary label 302, includes multiple luminescent dyes, inks, materials, etc. As such, depending on the implementation, the different luminescent dyes may have different excitation wavelengths. As such, an illumination device 104 may illuminate the label using multiple illumination light sources and/or a variable illumination light source. In other implementations, the different luminescent dyes have the same or similar excitation wavelengths. In such implementations, the illumination device 104 may illuminate the different luminescent dyes on the label substantially simultaneously and by using a single illumination light source.

In some implementations, the illumination device 104 determines one or more parameters of a label based on the luminescent dyes. For example, the illumination device 104 may determine the dimensions of the label based on the luminescent dyes. In the exemplary implementation of FIG. 3, label 302 includes fluorescent dye along two sides of the label 302. As such, the illumination device 104 determines the dimensions of the label by determining the length of each strip of fluorescent dye. In an embodiment, the illumination device may use a first illumination source to project light toward the label; receive emitted light and reflected light from the first strip; determine TDOA data; determine a distance from the label based on the received light; capture a 2D image of light received from the first strip and the second strip; determine a label length and a label width based on the captured image; and determine one or more parameters of the object 208 based on the label length, the label width, and the distance from the label to the illumination device. In an embodiment, the illumination device may use a first illumination source to project structured light toward the label, determine time differences of arrival (TDOA) of light received from two points on the first fluorescent strip (e.g., the endpoints of the first fluorescent strip), determine distances from the device to the two points based on the determined TDOA, and/or calculate a length of the first strip based on the determined distances. The illumination device may then project a second illumination light to repeat the process for the second strip. In an embodiment, an illumination device may project activation light, receive emitted light and reflected light from the two strip pattern in response to the projected light, determine 3D data for a plurality of points based on TDOA data from the received light, and/or determine one or more parameters of the label based on the determined 3D data. In an embodiment, the illumination device 104 determines one or more dimensions of the object 208 based on the dimensions of the label 302. Depending on the implementation, the illumination device 104 may determine dimensions of the object 208 by determining dimensions of the label, capturing an image of the object 208 and the label 302, and comparing lengths, pixel counts, and/or any other similar image analysis metric to determine the dimensions of the object 208 based on the captured image and/or the determined dimensions of the label.

In some implementations, the illumination device 104 may determine the shape of the object 208 based on the design of the label. For example, an illumination device 104 may determine based on the design of label 304 and/or label 306 that the object 208 is cylindrical, spherical, and/or another non-cuboidal shape. Depending on the implementation, the illumination device 104 may detect the shape of the label based on calculated distances for one or more points on the design, distances between points on the design, etc. In some implementations, the illumination device 104 stores various designs in a memory and compares the determined design to the stored designs to determine whether a design is detected. For example, if label 304 is 2 inches wide, 3 inches from a first strip to a fold line, and 3 inches from the fold line to a second strip parallel to the first strip, then detecting the first strip six inches from the second strip may indicate the label is applied to a flat surface of a parcel (or other object 208). Similarly, detecting the first strip approximately 3\sqrt{2} inches from the second strip may indicate the label is applied around a 90 degree corner of the parcel. Detecting the first strip at an intermediate distance from the second strip may indicate the label is applied to a non-cuboidal portion of the parcel.

If label 306 includes a 3 inch luminescent circle, detecting an ellipse with a 3 inch height and 3 inch width may indicate the label is applied to a flat surface of a parcel (or other object 208). Similarly, detecting an ellipse with a 3 inch width and 3/π inch height may indicate the label is applied to a cylinder of diameter

$$\frac{3}{π} \approx \text{.955}$$

inches. Detecting an ellipse with a 3 inch width and intermediate height may indicate the label is applied to a cylinder with a diameter greater than 0.955 inches. Detecting an arc of an ellipse with a width of 3 inches and a height less than 0.955 inches may indicate the label is applied to a cylinder with a diameter less than 0.955 inches.

Conventional dimensioning systems may model a plane of an object based on a 3D point cloud determined from light received from the object. As such, in further implementations, the luminescent dye is separated on the label 308, and the label 308 is applied to an object 208 such that portions of the label adjacent to different surfaces of the object 208 emit light of different wavelengths. The illumination device 104 may therefore detect the presence of an edge and/or recognize a plane based on the placement of the label 308 that a conventional system may be unable to detect. In some implementations, the object 208 is a color (e.g., black, dark brown, dark blue, and/or any other such dark color) such that a conventional system may have trouble detecting edges and/or planes. As such, the label 308 may improve the ability for an illumination device 104 to detect edges and/or planes of an object 208. In an embodiment, a portion of the label positionable adjacent to a first surface of the object 208 emits light of a first wavelength, a portion of the label positionable adjacent to a second surface of the object 208 emits light of a second wavelength; and the illumination device 104 projects activation light, determines first TDOA data based on emitted light received from the first surface in response to the projected light, determines second TDOA data based on emitted light received from the second surface in response to the projected light, determines a first object plane from the first TDOA data, determines a second object plane from the second TDOA data, and/or determines an object edge based to the first determined plane and the second determined plane.

In further implementations, the label 308 may include a third dye, and the label may be placed at a corner of three intersecting planes rather than two as depicted in the exemplary implementation of FIG. 3. In still further implementations, an object 208 may include two or more labels 308 on a corresponding number of different edges to assist the illumination device 104 in detecting each plane of the object 208 (for example, a top plane, a side plane, and another side plane). The illumination device 104 and/or an external computing device may fit a curve to each detected plane to determine an intersection and/or length of a line segment connecting any two planes. Similarly, in further implementations, each surface of the object 208 may include such a label instead. Depending on the implementation, each label may include a barcode, QR code, RFID tag, etc.

In an embodiment, the label may include multiple targets and/or a complex pattern (e.g., labels 310 and 312) such that the illumination device 104 may capture a patterned image with a single flash of projected light rather than (or in addition to) projecting structured light. Depending on the implementation, the projected light may be UV light, infrared (IR) light, or any other light with a wavelength corresponding to the excitation wavelength of a luminescent material carried by the label and creating the multiple targets or other pattern.

In some such implementations, the illumination device 104 may be positioned such that the illumination device 104 is not orthogonal to all textures and/or patterns on the label 310 or 312. In such implementation, the illumination device 104 may receive some light back in response to a flash of projected light sooner and may therefore determine that the light received sooner correlates to a portion of the label 310 or 312 that is closer to the illumination device 104. As such, the illumination device 104 determines a 3D point cloud of data based on the differences in received light, may use multivariable regression or other curve fitting algorithms to detect a plane from the determined 3D data, and dimension one or more faces of the object 208 based on the detected plane.

Depending on the implementation, the illumination device 104 may capture a 2D image of the object 208, such as via a sensor in the sensor assembly. In such cases, the illumination device 104 may correspond a portion of the 2D image to the gathered 3D point cloud and may subsequently determine a distance to pixel ratio, dimension, or other such parameter for the object 208 according to the 2D image.

It will be understood that, although FIG. 3 is largely described with regard to fluorescent dyes, such is for ease of comprehension only, and fluorescent inks, materials, etc. may also be used in place of fluorescent dyes. Similarly, other luminescent dyes, inks, materials, etc., may be used in addition to or in place of fluorescent ones. For example, a label may instead be printed using phosphorescent inks, dyes, materials, etc.

Referring next to FIG. 4 the method 400 illustrates a flow diagram of an example method for determining a distance to an object using light projected from an illumination device. Although the method 400 is described below with regard to illumination device 104 a remote server, another computing device, and/or other components of the system 100 as illustrated in FIG. 1 and/or the system 200 as illustrated in FIG. 2A, it will be understood that other similarly suitable imaging devices and components may be used instead.

At block 402, the illumination device 104 projects, from an illumination source (e.g., illumination light source 128), projected light having a first wavelength. Depending on the implementation, the first wavelength may be an excitation wavelength of a fluorophore, a phosphorescent material, and/or any other similarly luminescent material. In some implementations, the illumination device 104 projects activation light toward an object (e.g., object 208) to activate multiple fluorophores, phosphorescent materials, etc. The illumination device 104 may determine the wavelength(s) to project toward the object 208 based on user input, a preprogrammed (e.g., at runtime, during calibration, during manufacture, etc.) wavelength, based on a scanned barcode or RFID tag, and/or any similarly applicable technique. In an embodiment, an illumination device 104 comprising a sensor assembly captures an image from a field of view comprising a barcode, decodes a wavelength identifier from the barcode, selects an activation wavelength based on the wavelength identifier, and projects activation light of the selected wavelength.

At block 404, the illumination device 104 receives, at one or more sensors (e.g., sensors 126), reflected light having the first wavelength. At block 406, the illumination device 104 receives, at one or more sensors (e.g., sensors 126), emitted light having a second wavelength. Depending on the implementation, the reflected light and the emitted light may pass through an optical element before the illumination device 104 receives the respective light at the one or more sensors. The optical element (e.g., optical element 210) may be and/or include a prism, a diffraction grating, a transmission grating, and/or any other similar optical element that separates light based on the wavelength. Depending on the implementation, the optical element 210 may be part of the one or more sensors 126, part of the illumination device 104 and positioned between the one or more sensors 126 and the object 208, external to the illumination device 104 and positioned between the one or more sensors 126 and the object 208, etc.

In some such implementations, the optical element 210 redirects the light to the one or more sensors 126. Depending on the implementations, the one or more sensors may be different sensors (e.g., sensors 126A and 126B), each positioned to receive one of the reflected light or the emitted light; the same sensor (e.g., sensor 126), positioned to receive the reflected light and the emitted light at different positions; the same sensor positioned to receive the reflected light and the emitted light at different times and the same location; etc. As such, in some implementations in which the illumination device 104 includes an optical element 210, receiving the reflected light includes receiving the reflected light at the optical element 210, and the optical element deviates the reflected light at a first angle based on the wavelength of the reflected light. Similarly, in such implementations, receiving the emitted light includes receiving the emitted light at the optical element 210, and the optical element deviates the emitted light at a second angle based on the wavelength of the emitted light, and the first angle and the second angle are different.

At block 408, the illumination device 104 determines a phase difference between the reflected light and the emitted light. Depending on the implementation, the phase difference may be positive, negative, or zero based on the first speed of the reflected light 260, the second speed of the emitted light 265, the time T_{F} for the excitation and emission of the emitted light 265, and/or the distance from the object to the illumination device. Depending on the implementation, the illumination device 104 determines a phase difference between the reflected light and the emitted light based on: (i) the position of the respective sensor receiving each light beam, (ii) the location on a single sensor at which the sensor receives each light beam, (iii) the time at which the sensor(s) receive each light beam, and/or (iv) any other factor and/or combination of factors similar to those described herein, such as those described above with regard to FIG. 2A.

At block 410, the illumination device 104 determines a distance to the object based at least on the phase difference between the reflected light and the emitted light. In some implementations, the illumination device 104 determines the distance further based on a first time of flight representative of the reflected light and a second time of flight representative of the emitted light (e.g., the TDOA as described above with regard to FIG. 2A). In further implementations, the illumination device 104 determines the distance further based on the index of refraction adjustment, the fluorescence lag, phosphorescence lag, and/or any other similar factor to those described herein.

In some implementations, in addition to the illumination device 104 determining the distance to the object 208, the illumination device 104 also calculates multiple distances to various points on a surface of the object 208. In some implementations, the illumination device 104 determines three dimensional (3D) data for a plurality of points on a surface of the object 208 based on the calculated distances and may communicate the 3D data to a network 106 via a networking interface 122. In some implementations, the illumination device 104 determines the distance based on an average of the multiple estimated distances. In some implementations, the illumination device 104 determines one or more parameters of the object 208, such as a shape of the object or a pattern present on the object, based on the multiple determined distances.

In an embodiment, the illumination device 104 receives a second emitted light from the object 208, where the second emitted light has a different wavelength from both the reflected wavelength and the first emitted wavelength. In an embodiment, the wavelength of the second emitted light is the same wavelength as the first emitted wavelength, and results from the same luminescent dye as the first emitted light, but in a different position (e.g., similar to labels 310 and/or 312 as described with regard to FIG. 3). In an embodiment, the second emitted light is emitted from a different fluorescent dye than the first emitted light.

Depending on the implementation, the illumination device 104 determines a second phase difference between the reflected light and the second emitted light. The illumination device 104 may then use the second phase difference and the first phase difference to determine the distance to the object 208. In some implementations, the illumination device 104 determines a first distance based on the first phase difference and a second distance based on the second phase difference and averages the two distances to determine the distance between the illumination device 104 and the object 208. Similarly, the illumination device 104 may use the first phase difference and the second phase difference or the first distance and the second distance to determine other parameters of the object 208, such as dimensions of the object, and/or detecting features of the object 208, such as a plane or edge of the object, a shape of the object, or dimensions of the object.

Although FIG. 4 is described with regard to the illumination device 104, it will be understood that the illumination device 104 may instead transmit, via a networking interface 122, information related to the received light to an external computing device. In such implementations, the external computing device may capture, generate, and/or store data as described herein. In an embodiment, the illumination device 104 automatically transfers the generated data to the external computing device. In an embodiment, the illumination device 104 stores the data in memory belonging to the illumination device 104 so the external computing device may later request the data.

In the foregoing specification, specific implementations have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described implementations/examples/implementations should not be interpreted as mutually exclusive, and should instead be understood as potentially combinable if such combinations are permissive in any way. In other words, any feature disclosed in any of the aforementioned implementations/examples/implementations may be included in any of the other aforementioned implementations/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting implementation the term is defined to be within 10%, in another implementation within 5%, in another implementation within 1% and in another implementation within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various implementations for the purpose of streamlining the disclosure. This method of disclosure is not to be interpreted as reflecting an intention that the claimed implementations require more features than are expressly recited in each claim. Rather, as the following claims reflect, inventive subject matter may lie in less than all features of a single disclosed implementation. Thus, the following claims are hereby incorporated into the Detailed Description, with each claim standing on its own as a separately claimed subject matter.

The claims are:

1. A method for determining a distance to an object using projected light, the method comprising:
projecting, from an illumination source of an illumination device, light having a first wavelength;
receiving, at one or more sensors of the illumination device, reflected light having the first wavelength;
receiving, at the one or more sensors of the illumination device, emitted light having a second wavelength;
determining, by one or more processors, a phase difference between the reflected light and the emitted light; and
determining, by the one or more processors, the distance to the object based at least on the phase difference between the reflected light and the emitted light.

2. The method of claim 1, wherein the first wavelength is an excitation wavelength of a fluorophore and the second wavelength is an emission wavelength of the fluorophore.

3. The method of claim 1, wherein the first wavelength is an excitation wavelength of a phosphorescent material and the second wavelength is an emission wavelength of the phosphorescent material.

4. The method of claim 1, wherein:
receiving the reflected light includes:
receiving, at a prism of the illumination device, the reflected light, the prism deviating the reflected light at a first angle based on the first wavelength; and
receiving, at a first sensor position of the one or more sensors after the prism deviates the reflected light at the first angle, the reflected light; and
receiving the emitted light includes:
receiving, at the prism of the illumination device, the emitted light, the prism deviating the emitted light at a second angle based on the second wavelength; and
receiving, at a second sensor position of the one or more sensors after the prism deviates the emitted light at the second angle, the emitted light.

5. The method of claim 4, wherein the first sensor position of the one or more sensors is a first sensor position of a particular sensor of the one or more sensors and the second sensor position of the one or more sensors is a second sensor position of the particular sensor.

6. The method of claim 1, wherein determining the phase difference includes:
determining, by the one or more processors, a first phase associated with the reflected light based on at least a first sensor position of the one or more sensors;
determining, by the one or more processors, a second phase associated with the emitted light based on at least a second sensor position of the one or more sensors; and
determining, by the one or more processors, the phase difference based on at least the first phase and the second phase.

7. The method of claim 1, wherein:
receiving the reflected light includes:
receiving, at a diffraction grating of the illumination device, the reflected light, the diffraction grating diffracting the reflected light at a first angle based on the first wavelength; and
receiving, at a first sensor position of the one or more sensors after the diffraction grating diffracts the reflected light at the first angle, the reflected light; and
receiving the emitted light includes:
receiving, at the diffraction grating of the illumination device, the emitted light, the diffraction grating diffracting the emitted light at a second angle based on the second wavelength; and
receiving, at a second sensor position of the one or more sensors after the diffraction grating diffracts the emitted light at the second angle, the emitted light.

8. The method of claim 1, wherein determining the phase difference includes:
determining, by the one or more processors, a first phase associated with the reflected light based on at least a first sensor position of the one or more sensors;
determining, by the one or more processors, a second phase associated with the emitted light based on at least a second sensor position of the one or more sensors; and
determining, by the one or more processors, the phase difference based on at least the first phase and the second phase.

9. The method of claim 1, wherein:
receiving the reflected light includes:
receiving, at a prism of the illumination device, the reflected light, the prism deviating the reflected light at a first angle based on the first wavelength; and
receiving, at the one or more sensors after the prism deviates the reflected light at the first angle, the reflected light at a first moment in time; and
receiving the emitted light includes:
receiving, at the prism of the illumination device, the emitted light, the prism deviating the emitted light at a second angle based on the second wavelength; and
receiving, at the one or more sensors after the prism deviates the emitted light at the second angle, the emitted light at a second moment in time.

10. The method of claim 9, wherein determining the phase difference includes:
determining, by the one or more processors, a first phase associated with the reflected light based on at least the first moment in time;
determining, by the one or more processors, a second phase associated with the emitted light based on at least the second moment in time; and
determining, by the one or more processors, the phase difference based on at least the first phase and the second phase.

11. The method of claim 1, wherein determining the distance to the object includes:
determining, by the one or more processors, a first time of flight of the reflected light and a second time of flight associated with the emitted light; and
calculating, by the one or more processors, the distance to the object based at least on the first time of flight of the reflected light and the second time of flight associated with the emitted light.

12. The method of claim 1, wherein determining the distance to the object includes:
calculating, by the one or more processors, a plurality of estimated distances between the illumination device and a plurality of points on the object;
the method further comprising:
identifying, by the one or more processors, a shape of the object based on the plurality of estimated distances.

13. The method of claim 1, wherein determining the distance to the object includes:
calculating, by the one or more processors, a plurality of estimated distances between the illumination device and a plurality of points on the object;
the method further comprising:
identifying, by the one or more processors, a pattern of the object based on the plurality of estimated distances.

14. The method of claim 1, wherein the phase difference is a first phase difference, the emitted light is a first emitted light, and the method further comprising:
receiving, at the sensor of the illumination device, second emitted light having a third wavelength;
determining, by one or more processors, a second phase difference between the reflected light and the second emitted light; and
wherein determining the distance to the object is further based at least on the second phase difference between the reflected light and the second emitted light.

15. The method of claim 14, the method further comprising:
calculating, by the one or more processors, dimensions of the object based at least on the first phase difference and the second phase difference.

16. The method of claim 14, the method further comprising:
detecting, by the one or more processors, at least one of (i) a plane of the object or (ii) an edge of the object based at least on the first phase difference.

17. An illumination device capable of determining properties of an object using projected light, the illumination device comprising:
an illumination source configured to project light towards the object;
one or more sensors configured to receive light reflected or emitted from the object;
one or more processors and computer-readable media storing machine readable instructions that, when executed, cause the imaging device to:
project, from the illumination source, light having a first wavelength;
receive, at the one or more sensors, reflected light having the first wavelength;
receive, at the one or more sensors, emitted light having a second wavelength;
determine a phase difference between the reflected light and the emitted light; and
determine the distance to the object based at least on the phase difference between the reflected light and the emitted light.

18. The illumination device of claim 17, wherein the first wavelength is an excitation wavelength of a fluorophore and the second wavelength is an emission wavelength of the fluorophore.

19. The illumination device of claim 17, wherein the first wavelength is an excitation wavelength of a phosphorescent material and the second wavelength is an emission wavelength of the phosphorescent material.

20. The illumination device of claim 17, wherein:
the illumination device further comprises a prism disposed to deviate the reflected light at a first angle based on the first wavelength and deviate the emitted light at a second angle based on the second wavelength;
receiving the reflected light includes receiving, at a first sensor position of the one or more sensors after the prism deviates the reflected light at the first angle, the reflected light; and
receiving the emitted light includes receiving, at a second sensor position of the one or more sensors after the prism deviates the emitted light at the second angle, the emitted light.

21. The illumination device of claim 20, wherein the first sensor position of the one or more sensors is a first sensor position of a particular sensor of the one or more sensors and the second sensor position of the one or more sensors is a second sensor position of the particular sensor of the one or more sensors.

22. The illumination device of claim 17, wherein determining the phase difference includes:
determining, by the one or more processors, a first phase associated with the reflected light based on at least a first sensor position;
determining a second phase associated with the emitted light based on at least a second sensor position; and
determining the phase difference based on at least the first phase and the second phase.

23. The illumination device of claim 17, wherein:
the illumination device further comprises a diffraction grating disposed to diffract the reflected light at a first angle based on the first wavelength and diffract the emitted light at a second angle based on the second wavelength;
receiving the reflected light includes receiving, at a first sensor position of the one or more sensors after the diffraction grating diffracts the reflected light at the first angle, the reflected light; and
receiving the emitted light includes receiving, at a second sensor position of the one or more sensors after the diffraction grating diffracts the emitted light at the second angle, the emitted light.

24. The illumination device of claim 17, wherein determining the phase difference includes:
determining a first phase associated with the reflected light based on at least a first sensor position of the one or more sensors;
determining a second phase associated with the emitted light based on at least a second sensor position of the one or more sensors; and
determining the phase difference based on at least the first phase and the second phase.

25. The illumination device of claim 17, wherein:
the illumination device further comprises a prism disposed to deviate the reflected light at a first angle based on the first wavelength and deviate the emitted light at a second angle based on the second wavelength;
receiving the reflected light includes receiving, at the one or more sensors after the prism deviates the reflected light at the first angle, the reflected light at a first moment in time; and
receiving the emitted light includes receiving, at the one or more sensors after the prism deviates the emitted light at the second angle, the emitted light at a second moment in time.

26. The illumination device of claim 25, wherein determining the phase difference includes:
determining a first phase associated with the reflected light based on at least the first moment in time;
determining a second phase associated with the emitted light based on at least the second moment in time; and
determining the phase difference based on at least the first phase and the second phase.

27. The illumination device of claim 17, wherein determining the distance to the object includes:
determining, by the one or more processors, a first time of flight of the reflected light and a second time of flight associated with the emitted light; and
calculating the distance to the object based at least on the first time of flight of the reflected light and the second time of flight associated with the emitted light.

28. The illumination device of claim 17, wherein determining the distance to the object includes:
calculating, by the one or more processors, a plurality of estimated distances between the illumination device and a plurality of points on the object;
the method further comprising:
identifying, by the one or more processors, a shape of the object based on the plurality of estimated distances.

29. The illumination device of claim 17, wherein determining the distance to the object includes:
calculating, by the one or more processors, a plurality of estimated distances between the illumination device and a plurality of points on the object;
the method further comprising:
identifying, by the one or more processors, a pattern of the object based on the plurality of estimated distances.

30. The illumination device of claim 17, wherein the phase difference is a first phase difference, the emitted light is a first emitted light, and the machine readable instructions include instructions that, when executed, cause the illumination device to further:
receive, at the sensor, second emitted light having a third wavelength;
determine a second phase difference between the reflected light and the second emitted light; and
wherein determining the distance to the object is further based at least on the second phase difference between the reflected light and the second emitted light.

31. The illumination device of claim 30, wherein the machine readable instructions include instructions that that, when executed, cause the imaging device to:
calculate dimensions of the object based at least on the first phase difference and the second phase difference.

32. The illumination device of claim 30, wherein the machine readable instructions include instructions that, when executed, cause the imaging device to:
detect at least one of (i) a plane of the object or (ii) an edge of the object based at least on the first phase difference.
